(19) United States
(12) Patent Application Publication
(10) Pub. No.: US 2011/0025942 A1
(43) Pub. Date: Feb. 3, 2011

(54) LIQUID CRYSTAL DISPLAY DEVICE INCLUDING LED LIGHT SOURCE

(76) Inventor: Sook-Jin LEE, Gyeongsangbuk-do (KR)

Correspondence Address: MORGAN LEWIS & BOCKIUS LLP, 1111 PENNSYLVANIA AVENUE NW, WASHINGTON, DC, 20004, US

(21) Appl. No.: 12/636,066

(22) Filed: Dec. 11, 2009

(30) Foreign Application Priority Data
Jul. 31, 2009 (KR) 10-2009-0070643

(51) Int. Cl. G02F 1/1333; G02F 1/1335

(52) U.S. Cl. 349/58; 349/65

(57) ABSTRACT

A liquid crystal display device includes a support main having a rectangular frame shape, a reflection plate in the support main, a light guide plate over the reflection plate, a light-emitting diode (LED) assembly including LEDs arranged along a light-incident surface of the light guide plate and a metal core printed circuit board (MCPCB) on which the LEDs are mounted, a thermal conductive means contacting the MCPCB and having a thermal conductivity within a range of 1.5 to 3 W/m·K, a plurality of optical sheets over the light guide plate, a liquid crystal panel over the plurality of optical sheets, a cover bottom at a rear surface of the reflection plate and having a bottom wall and at least one side wall perpendicular to the bottom wall, wherein heats are conducted from the thermal conductive means to the at least one side wall, and a top cover covering edges of a front surface of the liquid crystal and combined with the support main and the cover bottom.

The invention claims the benefit of Korean Patent Application No. 10-2009-0070643 filed in Korea on Jul. 31, 2009, which is hereby incorporated by reference for all purposes as if fully set forth herein.

### BACKGROUND OF THE INVENTION

1. Field of the Invention

The invention relates to a liquid crystal display device, and more particularly, to a liquid crystal display device including a light-emitting diode (LED) light source.

2. Discussion of the Related Art

Liquid crystal display (LCD) devices are most widely used for monitors of notebook computers, monitors of personal computers and televisions due to excellent moving images and high contrast ratio. LCD devices use the optical anisotropy and polarization properties of liquid crystal molecules of a liquid crystal layer to produce an image.

An LCD device includes two substrates spaced apart and facing each other and a liquid crystal layer interposed between the two substrates. The alignment direction of the liquid crystal molecules is controlled by varying the intensity of an electric field applied to the liquid crystal layer, and the transmittance of light through the liquid crystal layer is changed.

The LCD devices require an additional light source because the LCD devices are not self-luminescent. Therefore, a backlight unit is disposed at a rear side of a liquid crystal (LC) panel and emits light into the LC panel, whereby discernible images can be displayed.

Backlight units include cold cathode fluorescent lamps (CCFLs), external electrode fluorescent lamps (EEFLs), and light emitting diodes (LEDs) as a light source. Among these, LED lamps have been widely used due to their small sizes, low power consumption, and high reliability.

FIG. 1 is a cross-sectional view illustrating a liquid crystal display (LCD) module including LEDs as a light source according to the related art.

In FIG. 1, the related art LCD module includes a liquid crystal panel 10, a backlight unit 20, a support main 30, a top cover 40 and a cover bottom 50.

The liquid crystal panel 10 displays images and includes first and second substrates 12 and 14 facing and attached to each other with a liquid crystal layer (not shown) interposed therebetween. Polarizers 19a and 19b are attached at front and rear surfaces of the liquid crystal panel 10 and control the polarization of light.

The backlight unit 20 is disposed at a rear side of the liquid crystal panel 10. The backlight unit 20 includes an LED assembly 29, a reflection plate 25, a light guide plate 23 and a plurality of optical sheets 21. The LED assembly 29 is disposed at an edge of at least one side of the support main 30 along a length direction. The reflection plate 25 is disposed over the cover bottom 50 and is white- or silver-colored. The light guide plate 23 is disposed over the reflection plate 25. The plurality of optical sheets 21 are disposed over the light guide plate 23.

The LED assembly 29 is disposed at a side of the light guide plate 23. The LED assembly 29 includes a plurality of LEDs 29a emitting white light and a printed circuit board (PCB) 29b on which the LEDs 29a are mounted.

Edges of the liquid crystal panel 10 and the backlight unit 20 are surrounded by the support main 30 having a rectangular frame shape. The top cover 40 covers edges of the front surface of the liquid crystal panel 10, and the cover bottom 50 covers a rear surface of the backlight unit 20. The top cover 40 and the cover bottom 50 are combined to with the support main 30 to thereby constitute one-united body.

FIG. 2 is a cross-sectional view of enlarging an area A of FIG. 1. In FIG. 2, the LEDs 29a are arranged along the side of the light guide plate 23 of the LCD module, and the LEDs 29a are mounted on the PCB 29b to constitute the LED assembly 29. The LED assembly 29 is fixed by a bonding method such that lights emitted from the LEDs 29a face a side surface of the light guide plate 23, which the lights are incident on and which is referred to as a light-incident surface hereinafter. To do this, the cover bottom 50 has a rectangular plate shape and includes a side wall that is formed by bending an edge portion of the cover bottom 50 upward. The LED assembly 29 is attached and fixed to the side wall of the cover bottom 50 by an adhesive material such as a both-sided sticky tape. The structure may be referred to as a side top view type.

Accordingly, lights emitted from the LEDs 29a are incident on the light-incident surface of the light guide plate 23 and then are refracted toward the liquid crystal panel 10 inside the light guide plate 23. With lights reflected by the reflection plate 25, the lights are changed to have uniform brightness and high qualities through the plurality of optical sheets 21 and are provided to the liquid crystal panel 10. Accordingly, the liquid crystal panel 10 displays images.

By the way, the LEDs 29a are luminous elements, and temperatures of the LEDs 29a rapidly increase according as using time passes. The increasing temperatures cause changes in the brightness. Therefore, it is important to radiate heat from the LEDs 29a when the LEDs 29a are used for a light source of the backlight unit 20.

However, in the related art LCD device, there is no specific way to send out heat of the LEDs 29a quickly to the outside, and the temperatures of the LEDs 29a gradually increase while used. According to this, the brightness is changed, and image qualities are lowered.

To solve the problem, a metal core printed circuit board (MCPCB), which has a function for radiation of heat due to conduction, has been used for the PCB 29b so that the heats of the LEDs 29a are conducted to the MCPCB and radiated.

However, the PCB 29b is attached to the cover bottom 50 by an adhesive material 27. The adhesive material 27 has a low thermal conductivity of about 9.8 W/m·K, and it is hard to effectively conduct the heats from the MCPCB to the cover bottom 50. Accordingly, the heats of the LED are not efficiently radiated.

### SUMMARY OF THE INVENTION

Accordingly, the present invention is directed to a liquid crystal display device including an LED light source that substantially obviate one or more of the problems due to limitations and disadvantages of the related art.

An advantage of the present invention is to provide a liquid crystal display device including an LED light source that effectively radiates heats generated in the LED light source.

Another advantage of the present invention is to provide a liquid crystal display device including an LED light source that reduces production costs.

Additional features and advantages of the invention will be set forth in the description which follows, and in part will be apparent from the description, or may be learned by practice of the invention. These and other advantages of the invention will be realized and attained by the structure particularly pointed out in the written description and claims hereof as well as the appended drawings.

To achieve these and other advantages and in accordance with the purpose of embodiments of the invention, as embodied and broadly described, a liquid crystal display device includes a support main having a rectangular frame shape, a reflection plate in the support main, a light guide plate over the reflection plate, a light-emitting diode (LED) assembly including LEDs arranged along a light-incident surface of the light guide plate and a metal core printed circuit board (MCPCB) on which the LEDs are mounted, a thermal conductive means contacting the MCPCB and having a thermal conductivity within a range of 1.5 to 3 W/m·K, a plurality of optical sheets over the light guide plate, a liquid crystal panel over the plurality of optical sheets, a cover bottom at a rear surface of the reflection plate and having a bottom wall and at least one side wall perpendicular to the bottom wall, wherein heats are conducted from the thermal conductive means to the at least one side wall, and a top cover covering edges of a front surface of the liquid crystal and combined with the support main and the cover bottom.

In another aspect, a liquid crystal display device includes a support main having a rectangular frame shape, a reflection plate in the support main, a light guide plate over the reflection plate, a light-emitting diode (LED) assembly including LEDs arranged along a light-incident surface of the light guide plate and a metal core printed circuit board (MCPCB) on which the LEDs are mounted, a thermal conductive means contacting the MCPCB, a plurality of optical sheets over the light guide plate, a liquid crystal panel over the plurality of optical sheets, a cover bottom at a rear surface of the reflection plate and having a bottom wall and at least one side wall perpendicular to the bottom wall, wherein the thermal conductive means contacts the at least one side wall, a top cover covering edges of a front surface of the liquid crystal and combined with the support main and the cover bottom, and a clip guide covering the LED assembly, the thermal conductive means and the at least one side wall.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a cross-sectional view illustrating a liquid crystal display (LCD) module including LEDs as a light source according to the related art;

FIG. 2 is a cross-sectional view of enlarging an area A of FIG. 1;

FIG. 3 is an exploded perspective view of illustrating an LCD device according to a first embodiment of the present invention;

FIG. 4A is an exploded perspective view of schematically illustrating a radiation means of heats according to the first embodiment of the present invention, FIG. 4B is a perspective view of illustrating the combined radiation means of heats of FIG. 4A, and FIG. 4C is a perspective view of schematically illustrating another fixing portion according to the first embodiment of the present invention;

FIGS. 5A and 5B are cross-sectional views of schematically illustrating paths of heats of LEDs according to the first embodiment of the present invention;

FIG. 6 is an exploded perspective view of illustrating an LCD device according to a second embodiment of the present invention;

FIG. 7 is a perspective view of schematically illustrating a structure of a clip guide according to the present invention;

FIG. 8A is an exploded perspective view of schematically illustrating a radiation means of heats according to the second embodiment of the present invention, and FIG. 8B is a perspective view of illustrating the combined radiation means of heats of FIG. 8A;

FIG. 9 is a cross-sectional view of schematically illustrating a path of heats of LEDs according to the second embodiment of the present invention;

FIG. 10 is a perspective view of schematically illustrating a reflection plate 125 according to the present invention;

FIG. 11 is a cross-sectional view of schematically illustrating a structure of an LCD device of the first embodiment that adopts a reflection plate including a bending portion according to the present invention; and

FIG. 12 is a cross-sectional view of schematically illustrating a structure of an LCD device of the second embodiment that adopts a reflection plate including a bending portion according to the present invention.

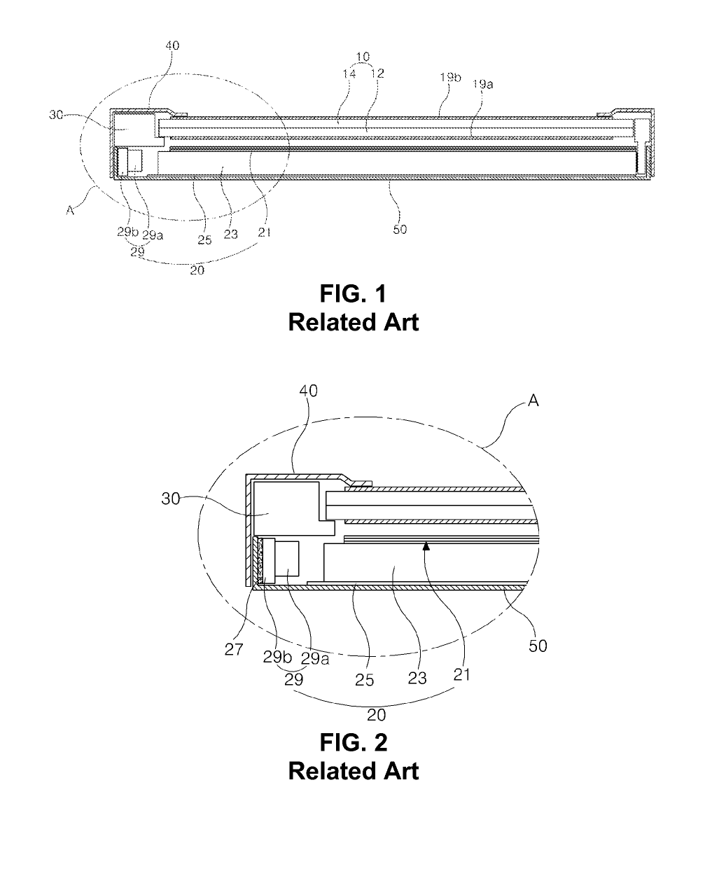

### DETAILED DESCRIPTION OF THE PREFERRED EMBODIMENTS

Reference will now be made in detail to embodiments of the present invention, examples of which are illustrated in the accompanying drawings.

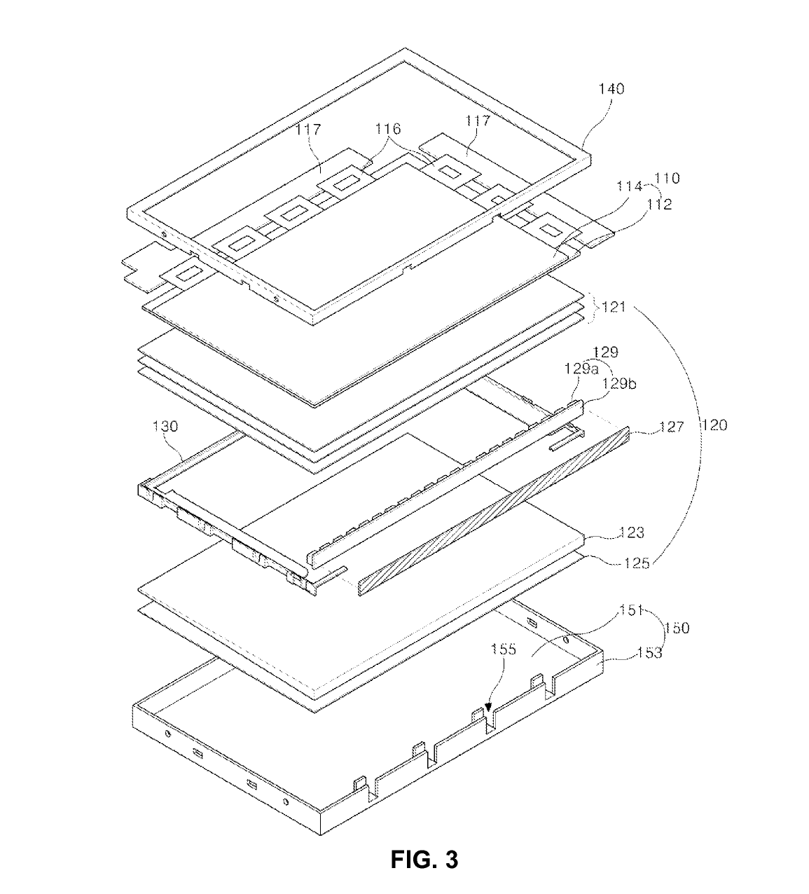

FIG. 3 is an exploded perspective view of illustrating an LCD device according to a first embodiment of the present invention.

In FIG. 3, an LCD module includes a liquid crystal panel 110, a backlight unit 120, a support main 130, a top cover 140 and a cover bottom 150.

More particularly, the liquid crystal panel 110 displays images. The liquid crystal panel 110 includes first and second substrates 112 and 114 facing and attached to each other with a liquid crystal layer (not shown) interposed therebetween. In an active matrix-type, although not shown in the figure, gate lines and data lines are formed on an inner surface of the first substrate 112, which may be referred to as a lower substrate or an array substrate. The gate lines and the data lines cross each other to define pixel regions. A thin film transistor (TFT) is formed at each crossing point of the gate and data lines, and a pixel electrode is connected to the thin film transistor at each pixel region. The pixel electrode may be formed of a transparent conductive material.

A black matrix and red, green and blue color filter patterns are formed on an inner surface of the second substrate 114, which may be referred to as an upper substrate or a color filter substrate. The color filter patterns correspond to the pixel regions, respectively. The black matrix surrounds each of the color filter patterns and covers the gate lines, the data lines, and the thin film transistors. A transparent common electrode is formed over the color filter patterns and the black matrix.

Polarizers (not shown) are attached to outer surfaces of the first and second substrates 112 and 114 and selectively transmit linearly polarized light.

A printed circuit board 117 is attached to at least a side of the liquid crystal panel 110 via connecting means 116 such as flexible printed circuit boards or tape carrier packages (TCPs), for example. The printed circuit board 117 is bent toward a side surface of the support main 130 or a rear surface of the cover bottom 150 during a module assembly process.

In the liquid crystal panel 110, on/off signals from gate driving circuits are provided to the thin film transistors through the gate lines, and when the thin film transistors selected by each gate line turn on, data signals from data driving circuits are provided to the pixel electrodes through the data line. According to this, an electric field is induced between the pixel electrodes and the common electrode, and the arrangement of the liquid crystal molecules is changed by the electric field to thereby change transmittance of light. Therefore, the liquid crystal panel 110 displays variances in the transmittance as images.

The backlight unit 120 is disposed under the liquid crystal panel 110 and provides light to the liquid crystal panel 110 so that the variances in the transmittance of the liquid crystal panel 110 are shown to the outside.

The backlight unit 120 includes a light-emitting diode (LED) assembly 129, a reflection plate 125 of a white or silver color, a light guide plate 123 over the reflection plate 125, and optical sheets 121 over the light guide plate 123.

The LED assembly 129 is disposed at a side of the light guide plate 123 such that the LED assembly 129 faces a light-incident surface of the light guide plate 123, which light is incident on. The LED assembly 129 includes a plurality of LEDs 129a and a printed circuit board (PCB) 129b on which the LEDs 129a are mounted to be spaced apart from each other.

The LEDs 129a include red (R), green (G) and blue (B) LEDs respectively emitting red, green and blue lights toward the light-incident surface of the light guide plate 123. A white light is produced by lighting the RGB LEDs 129a up at a time and then mixing the red, green and blue lights.

Alternatively, each of the LEDs 129a may include LED chips emitting red, green and blue lights, and each LED 129a may produce a white light. The LED 129a may include a chip emitting a white light and emit a full white light.

Meanwhile, the LEDs 129a respectively emitting red, green and blue lights may be mounted as a cluster, and the plurality of LEDs 129a may be arranged on the PCB 129b in a line or in several lines.

The LEDs 129a are luminous elements, and temperatures of the LEDs 129a rapidly increase according as using time passes. The increasing temperatures cause changes in the brightness. Therefore, it is important to design conditions for radiating heat from the LEDs 129a when the LEDs 129a are used for a light source of the backlight unit 120.

In the prevent invention, a metal core printed circuit board (MCPCB) is used for the PCB 129b, which the LEDs 129a are mounted on, so that the heats of the LEDs 129a are rapidly conducted to the MCPCB. The backlight unit 120 further includes a tape-shaped heat sink 127, which is referred to as a gap pad hereinafter. Therefore, in the LCD device according to the first embodiment of the present invention, even though the LEDs 129a are used for a long time, there is no increase in the temperatures of the LEDs 129a.

Here, the gap pad 127 is interposed between the MCPCB 129b of the LED assembly 129 and the cover bottom 150. The gap pad 127 forms a path for radiation of heat connecting the MCPCB 129b and the cover bottom 150 and conducts heats of the LEDs 129a to the cover bottom 150. Accordingly, the LCD device according to the first embodiment of the present invention has an efficient structure for radiating the heats of the LED assembly 129. This will be explained in more detail later.

The light guide plate 123 totally reflects lights emitted from the LEDs 129a several times such that the lights move through the inside of the light guide plate 123 and are uniformly scattered. Accordingly, an initial plane light source is provided to the liquid crystal panel 110. To provide a uniform plane light source, the light guide plate 123 may include predetermined patterns at its rear surface. Here, to guide the lights incident on the inside of the light guide plate 123, the patterns may be elliptical patterns, polygonal patterns or hologram patterns. The patterns may be formed by a printing method or an injecting method.

The reflection plate 125 is disposed under the rear surface of the light guide plate 123. The reflection plate 125 reflects lights passing through the rear surface of the light guide plate 123 toward the liquid crystal panel 110 to increase the brightness.

The optical sheets 121 over the light guide plate 123 include a diffuser sheet and at least a light-concentrating sheet. The optical sheets 121 diffuse or concentrate lights passing through the light guide plate 123 such that more uniform plane light source is provided to the liquid crystal panel 110.

The liquid crystal panel 110 and the backlight unit 120 are modularized with the top cover 140, the support main 130 and the cover bottom 150. The top cover 140 has a rectangular frame shape with an L-shaped cross-section to cover edges of a front surface and side surfaces of the liquid crystal panel 110. A front surface of the top cover 140 has an opening, wherein images of the liquid crystal panel 110 are displayed through the opening.

The cover bottom 150, which the liquid crystal panel 110 and the backlight unit 120 are disposed over and which is a base of the liquid crystal display module, has a rectangular plate shape, and four edges of the cover bottom 150 are bent perpendicularly toward the liquid crystal panel 110. Thus, the cover bottom 150 may include a bottom wall and four side walls.

The support main 130 has a rectangular frame shape with an opened side. The support main 130 is disposed over the cover bottom 150 and surrounds edges of the liquid crystal panel 110 and the backlight unit 120. The support main 130 is combined with the top cover 140 and the cover bottom 150.

The top cover 140 may be referred to as a case top or a top case, the support main 130 may be referred to as a guide panel, a main support or a mold frame, and the cover bottom 150 may be referred to as a bottom cover or a lower cover.

The gap pad 127 has a higher thermal conductivity than the adhesive material 27 of FIG. 2 and efficiently conducts the heats of the LEDs 129a to the cover bottom 150 through the MCPCB 129b. The thermal conductivity of the gap pad 127 may be within a range of 1.5 to 3 W/m·K. Accordingly, in the present invention, the heats of the LEDs 129a can be quickly and efficiently radiated to the outside due to the efficient design for the radiation of the LED assembly 129.

Here, the gap pad 127 may not have an adhesive property, and an additional means may be needed to fix positions of the gap pad 127 and the LED assembly 129. To fix and combine the gap pad 127 and the LED assembly 129, the cover bottom 150 according to the first embodiment of the present invention may include fixing portions 155 at one side wall 153, where the LED assembly 129 and the gap pad 127 are disposed.

The backlight unit 120 having the above-mentioned structure may be referred to as a side light type. The LEDs 120a may be arranged on the MCPCB 129b in several lines according to purposes. Furthermore, one or more LED assemblies 129 may be disposed at each of opposite side walls of the cover bottom 150 facing each other and may correspond to each other. In this case, the fixing portions 155 are formed at each of the opposite side walls 153.

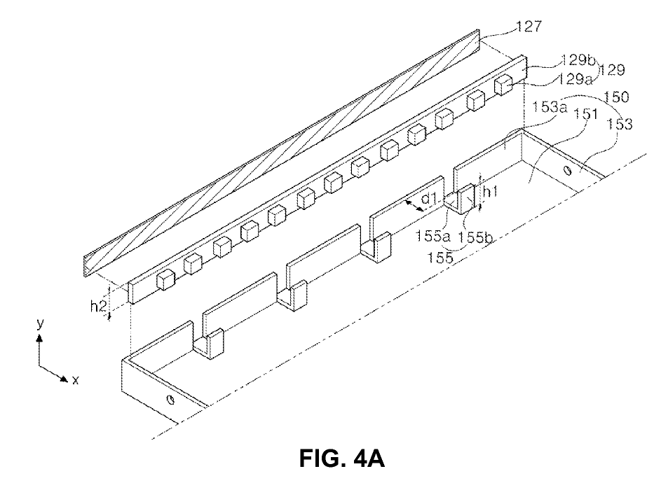

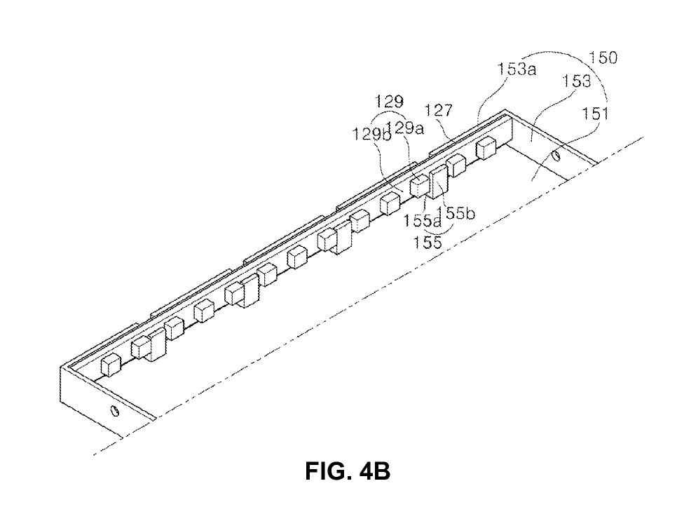

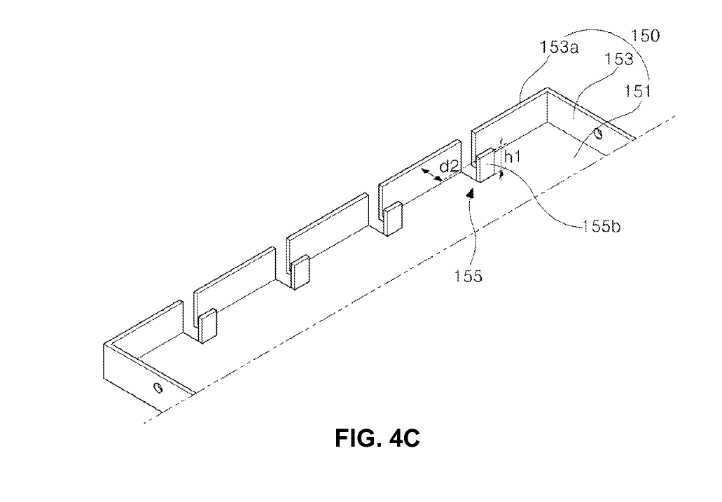

FIG. 4A is an exploded perspective view of schematically illustrating a radiation means of heats according to the first embodiment of the present invention. FIG. 4B is a perspective view of illustrating the combined radiation means of heats of FIG. 4A. FIG. 4C is a perspective view of schematically illustrating another fixing portion according to the first embodiment of the present invention.

In FIGS. 4A and 4B, the LEDs 129a are mounted on a first surface of the MCPCB 129b and spaced apart from each other. The gap pad 127 is disposed at a second surface of the MCPCB 129b, which is opposite to the first surface. The LED assembly 129 is positioned and fixed at an inner surface of the side wall 153a of the cover bottom 150.

More particularly, four edges of the cover bottom 150 are bent perpendicularly upward in the context of the figure. Thus, the cover bottom 150 includes a bottom wall 151 and four side walls 153 perpendicular to the bottom wall 151. The fixing portions 155 are formed at one side wall 153a, where the LED assembly 129 and the gap pad 127 are disposed.

Each of the fixing portions 155 includes a first part 155a and a second part 155b. The first part 155a is a part of the side wall 153a that is bent perpendicularly inward in the context of the figure. The first part 155a is parallel to the bottom wall 151 of the cover bottom 150. The first part 155a contacts and faces the bottom wall 151 of the cover bottom 150. The second part 155b is bent perpendicularly upward with respect to the first part 155a. The second part 155b is spaced apart from the side wall 153a of the cover bottom 150 with a predetermined distance, which corresponds to a length d1 of the first part 155a, and is parallel to the side wall 153a. The first part 155a is connected to the side wall the side wall 153a and the second part 155b and interposed therebetween.

Accordingly, the LED assembly 129 and the gap pad 127 are inserted between the side wall 153a of the cover bottom 150 and the second part 155b of the fixing portion 155 from the upside to the downside such that the LED assembly 129 and the gap pad 127 are positioned on the first part 155a and disposed between the side wall 153a and the second part 155b. The LED assembly 129 and the gap pad 127 are prevented from moving along a x-direction due to the side wall 153a and the second part 155b and prevented from moving along an y-direction due to the bottom wall 151 of the cover bottom 150 and the support main 130 of FIG. 3 and the top cover 140 of FIG. 3, which are combined with the cover bottom 150 later, in the context of the figure. Here, the x- and y-directions are perpendicular to each other and are parallel to the bottom wall 151 and the side wall 153a, respectively.

Beneficially, the length d1 of the first part 155a corresponds to a total thickness of the LED assembly 129 and the MCPCB 129b, and a height h1 of the second part 155b corresponds to a width h2 of the MCPCB 129b. Moreover, it is desirable that the second part 155b is disposed between adjacent LEDs 129a mounted on the MCPCB 129b in order not to affect lights emitted from the LEDs 129a.

The gap pad 127 is formed of a silicon composition that has a relatively high thermal conductivity. The silicon composition is flexible and is easily transformed by the external force. The gap pad 127 is close up and coupled with the LED assembly 129 and the side wall 153a of the cover bottom 150.

Alternatively, the gap pad 127 may be formed of a resin composition such as epoxy including a thermal conductive filler. The thermal conductive filler may be a material having a relatively high thermal conductivity such as aluminum, graphite or copper and may be powdered.

Like this, by inserting the gap pad 127 between the LED assembly 129 and the side wall 153a of the cover bottom 150, the heats of the LEDs 129a are conducted to the cover bottom 150 through the MCPCB 129b and the gap pad 127.

Meanwhile, as shown in FIG. 4C, the fixing portion 155 may include only a part 155b parallel to the side wall 153a, and the bottom wall 151 adjacent to the side wall 153a of the cover bottom 150 may be partially cut to correspond to the part 155b. For example, the bottom wall 151 may be partially cut, and the cut part of the bottom wall 151 may be bent perpendicularly upward in the context of the figure. The part 155b of the fixing portion 155 is spaced apart from the side wall 153a by a distance d1 and has a height h1. The part 155b is directly connected to the bottom wall 151.

That is, in FIG. 4C, as compared to the fixing portion 155 of FIGS. 4A and 4B including the first and second parts 155a and 155b, a part of the bottom wall 151 of the cover bottom 150 corresponding to the first part 155a of FIGS. 4A and 4B is cut, and only the second part 155b of FIGS. 4A and 4B remains.

Here, a distance d2 between the side wall 153a of the cover bottom 150 and the part 155b of the fixing portion 155, beneficially, corresponds to a sum of thicknesses of the MCPCB 129b of the LED assembly 129 and the gap pad 127 of FIG. 4A. It is desirable that a height h1 of the part 155b corresponds to the width h2 of the MCPCB 129b of FIG. 4A.

The terms for the first and second parts 155a and 155b may be changed to each other. Namely, the part 155b may be designated as a first part, and the part 155a may be designated to as a second part.

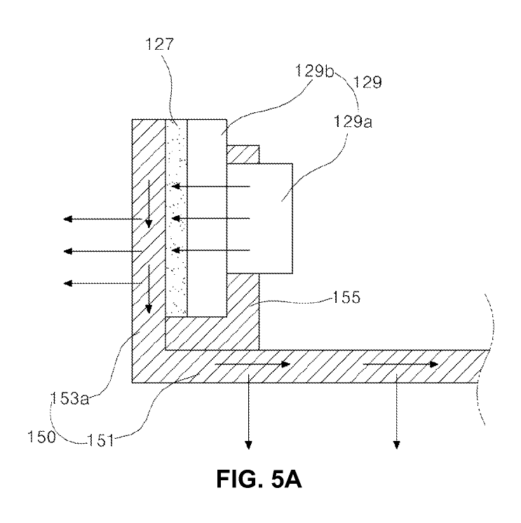

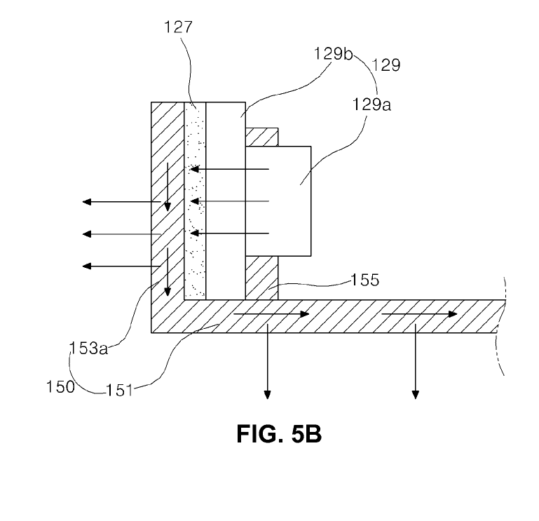

FIGS. 5A and 5B are cross-sectional views of schematically illustrating paths of heats of LEDs according to the first embodiment of the present invention.

In FIGS. 5A and 5B, when the LEDs 129a are driven, heats generated in the LEDs 129a are conducted to the MCPCB 129b and then transferred to the gap pad 127 that is close up the MCPCB 129b.

Since the gap pad 127 has a relatively high thermal conductivity, the heats transferred to the gap pad 127 move to the side wall 153a of the cover bottom 150, which is close up the gap pad 127, and then the heats are diffused into the whole cover bottom 150 including the bottom wall 151.

The heats diffused into the whole cover bottom 150 increasingly contact the exterior air. According to this, the heats generated in the LEDs 129a are quickly and efficiently released to the outside. Therefore, the problems that the lifespan of the LEDs 129a are shortened or the image qualities are lowered due to change of the brightness are prevented.

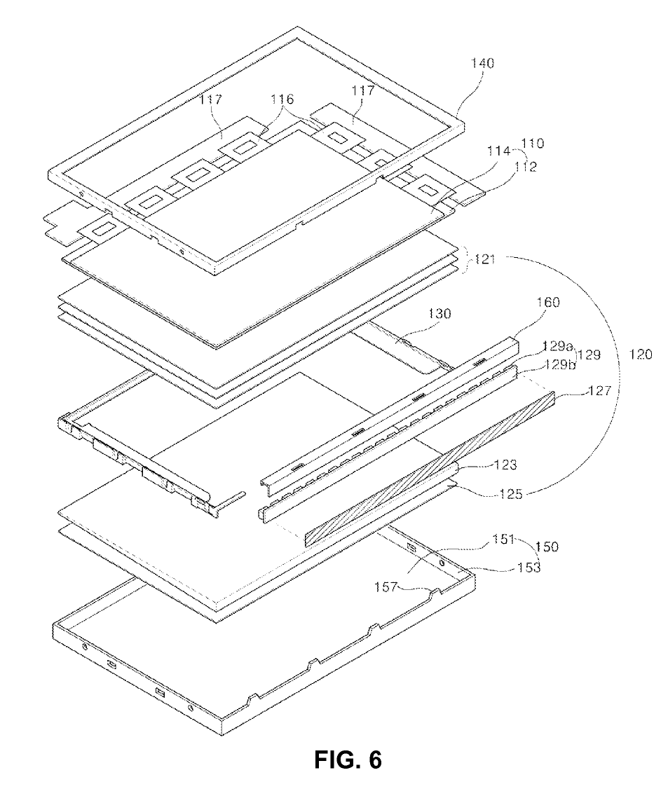

FIG. 6 is an exploded perspective view of illustrating an LCD device according to a second embodiment of the present invention. In the second embodiment, the same parts as the first embodiment are designated as the same references, and explanation for the same parts may be omitted.

In FIG. 6, a backlight unit 120 includes a reflection plate 125, a light guide plate 123, an LED assembly 129 at a side of the light guide plate 123, and optical sheets 121 over the light guide plate 123. The LED assembly 129 includes a plurality of LEDs 129a and a PCB 129b on which the LEDs 129a are mounted.

A liquid crystal panel 110 is disposed over the backlight unit 120. The liquid crystal panel 110 includes first and second substrates 112 and 114 and a liquid crystal layer (not shown) interposed therebetween. Polarizers (not shown) are attached to outer surfaces of the first and second substrates 112 and 114 and selectively transmit linearly polarized light.

The liquid crystal panel 110 and the backlight unit 120 are modularized with the top cover 140, the support main 130 and the cover bottom 150. Edges of the backlight unit 120 and the liquid crystal panel 110 are surrounded by a support main 130. A cover bottom 150 is combined with the support main 130 at a rear surface of the backlight unit 120, and a top cover 140 covering edges of a front surface and side surfaces of the liquid crystal panel 110 is united with the support main 130 and the cover bottom 150.

The cover bottom 150 has a rectangular plate shape, and four edges of the cover bottom 150 are bent perpendicularly toward the liquid crystal panel 110. Thus, the cover bottom 150 may include a bottom wall 151 and four side walls 153, wherein the bottom wall 151 is close up the rear surface of the backlight unit 120.

In the second embodiment, an MCPCB is used for the PCB 129b, which the LEDs 129a are mounted on, so that the heats of the LEDs 129a are rapidly conducted to the MCPCB 129b. The backlight unit 120 further includes a gap pad 127. Accordingly, in the LCD device according to the second embodiment of the present invention, even though the LEDs 129a are used for a long time, there is no increase in the temperatures of the LED 129a.

Here, the gap pad 127 is interposed between the MCPCB 129b of the LED assembly 129 and the cover bottom 150. The gap pad 127 forms a path for radiation of heat connecting the MCPCB 129b and the cover bottom 150.

The gap pad 127 has a relatively high thermal conductivity within a range of 1.5 to 3 W/m·K. Since the gap pad 127 has an adhesive property, an additional means may be needed to fix positions of the gap pad 127 and the LED assembly 129.

To fix the gap pad 127 and the LED assembly 129 at one side wall 153 of the cover bottom 150, the LCD device according to the second embodiment of the present invention may include a clip guide 160 to cover the LED assembly 129, the gap pad 127 and the side wall 153 of the cover bottom 150.

The clip guide 160 is combined with protrusions 157 formed at the side wall 153 of the cover bottom, and the gap pad 127, the LED assembly 129 and the side wall 153 of the cover bottom 150 are united in a body by the clip guide 160.

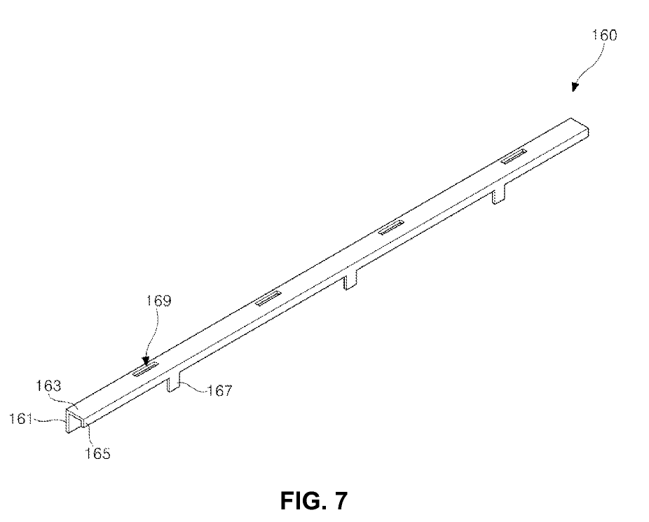

FIG. 7 is a perspective view of schematically illustrating a structure of a clip guide according to the present invention.

In FIG. 7, the clip guide 160 includes a first guide portion 161, a second guide portion 163 and a third guide portion 165. The second guide portion 163 is perpendicular to the first guide portion 161, and the third guide portion 165 is perpendicular to the second guide portion 163 and parallel to the first guide portion 161. The second guide portion 163 is disposed between the first and third guide portions 161 and 165 and connects the first and third guide portions 161 and 165. The third guide portion 165 has a smaller width than the first portion 161.

The first guide portion 161 covers an outer surface of the side wall 153 of the cover bottom 150 of FIG. 6. The second guide portion 163 guides and covers upper parts of the side wall 153 of FIG. 6, the gap pad 127 of FIG. 6 and the LED assembly 129 of FIG. 6 in the context of the figure. The third guide portion 165 partially covers an inner surface of the LED assembly 129 of FIG. 6, and more particularly, an inner surface of the MCPCB 129b of FIG. 6. Namely, the clip guide 160 has a cross-section of a cornered asymmetric U-like shape to cover the outer surface of the side wall 153 of the cover bottom 150 of FIG. 6, the upper parts of the gate pad 127 of FIG. 6 and the LED assembly 129 of FIG. 6, and a part of the inner surface of the LED assembly 129 of FIG. 6.

The second guide portion 163 of the clip guide 160 has connection holes 169 so that the clip guide 160 is combined and fixed with the cover bottom 150 of FIG. 6. The connection holes 169 correspond to the protrusions 157 of the side wall 153 of the cover bottom 150 of FIG. 6. The protrusions 157 pass through the connection holes 169, respectively, and the clip guide 160 is fixed to the cover bottom 150 of FIG. 6.

Moreover, the clip guide 160 may further include guide projections 167 at the third guide portion 165 partially covering the inner surface of the LED assembly 129 of FIG. 6. The guide projections 167 may be spaced apart from each other and may extend from the third guide portion 165. Accordingly, it is possible to increase a force for fixing the LED assembly 129 of FIG. 6 and the gap pad 127 of FIG. 6 to the cover bottom 150 of FIG. 6 due to the clip guide 160. Here, each of the guide projections 167 is disposed between adjacent LEDs 129a mounted on the MCPCB 129b in order not to affect lights emitted from the LEDs 129a.

Accordingly, the gap pad 127, the LED assembly 129 and the side wall 153 of the cover bottom 150 are united in a body due to the clip guide 160.

The clip guide 160 may be formed of a metallic material, plastic or other materials.

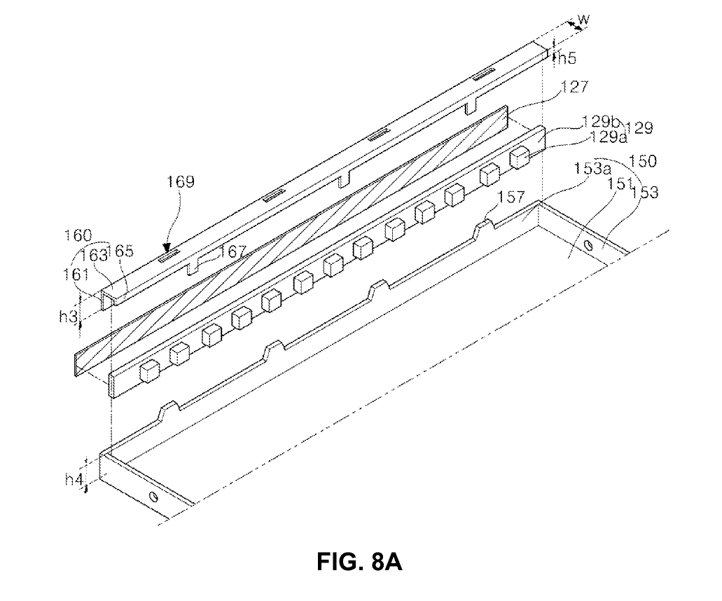

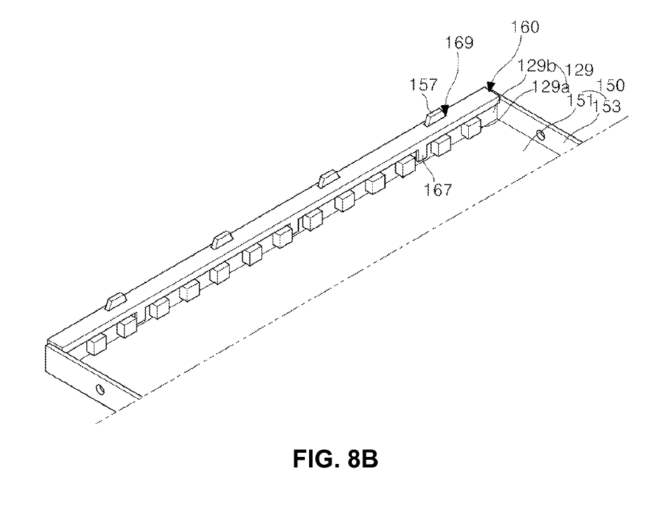

FIG. 8A is an exploded perspective view of schematically illustrating a radiation means of heats according to the second embodiment of the present invention. FIG. 8B is a perspective view of illustrating the combined radiation means of heats of FIG. 8A.

In FIGS. 8A and 8B, the LEDs 129a are mounted on a first surface of the MCPCB 129b and spaced apart from each other. The gap pad 127 is disposed at a second surface of the MCPCB 129b, which is opposite to the first surface. The LED assembly 129 is positioned and fixed at an inner surface of one side wall 153a of the cover bottom 150.

More particularly, four edges of the cover bottom 150 are bent perpendicularly upward in the context of the figure. Thus, the cover bottom 150 includes a bottom wall 151 and four side walls 153 perpendicular to the bottom wall 151. The LED assembly 129 and the gap pad 127 are fixed at the side wall 153a of the cover bottom 150. At this time, the LED assembly 129, the gap pad 127 and the side wall 153a of the cover bottom 150 are united in a body by the clip guide 160, which includes the first, second and third guide portions 161, 163 and 165.

That is, the gap pad 127 and the LED assembly 129 are disposed at the side wall 153a of the cover bottom 150, and the clip guide 160 is inserted from the upside to the downside such that the clip guide 160 covers the outer surface of the side wall 153a of the cover bottom 150, the upper parts of the gap pad 127 and the LED assembly 129, and the part of the inner surface of the LED assembly 129. Therefore, the gap pad 127, the MCPCB 129b and the LEDs 129a are sequentially disposed on an inner surface of the side wall 153a of the cover bottom 150, and the first guide portion 161 is disposed on the outer surface of the side wall 153a.

At this time, the protrusions 157 are formed at the side wall 153a of the cover bottom 150 to correspond to the connection holes 169 of the clip guide 160. The protrusions 157 pass through the connection holes 169, respectively, and the clip guide 160 is fixed to the cover bottom 150.

Accordingly to this, the gap pad 127 and the LED assembly 129 are fixed to the side wall 153a of the cover bottom 150, and the heats generated in the LEDs 129a are conducted to the cover bottom 150 through the MCPCB 129b and the gap pad 127.

The clip guide 160 has a length corresponding to that of the LED assembly 129. It is desirable that a height h3 of the first guide portion 161 corresponds to a height h4 of the side wall 153a of the cover bottom 150 such that the first guide portion 161 covers the outer surface of the side wall 153a of the cover bottom 150.

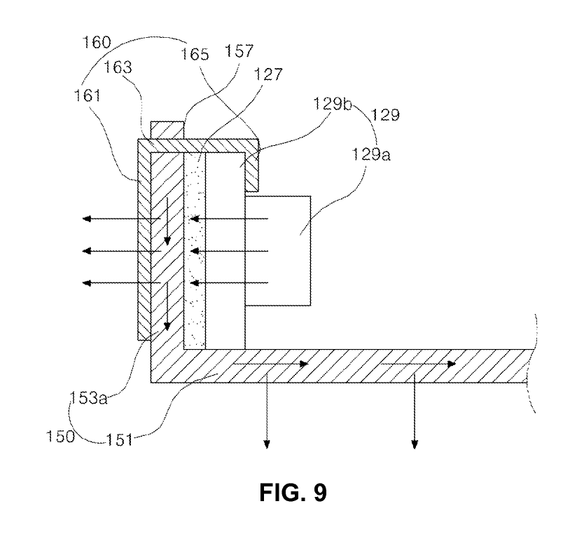

FIG. 9 is a cross-sectional view of schematically illustrating a path of heats of LEDs according to the second embodiment of the present invention.

In FIG. 9, since the gap pad 127, the LED assembly 129 and the side wall 153a of the cover bottom 150 are united in a body by the clip guide 160, when the LEDs 129a are driven, the heats generated in the LEDs 129a are conducted to the MCPCB 129b. The heats conducted to the MCPCB 129b move to the gap pad 127, which is close up the MCPCB 129b, and move to the side wall 153a of the cover bottom 150, which is close up the gap pad 127.

Next, the heats transferred to the side wall 153a of the cover bottom 150 are conducted to the clip guide 160 or effectively diffused into the whole cover bottom 150 including the bottom wall 151.

The heats diffused into the clip guide 160 and the whole cover bottom 150 contacts the exterior air in an increasing area. According to this, the heats generated in the LEDs 129a are quickly and efficiently released to the outside. Therefore, the problems that the lifespan of the LEDs 129a are shortened or the image qualities are lowered due to change of the brightness are prevented.

In the second embodiment, when the clip guide 160 is formed of a metallic material, an area contacting the exterior air may be further increased, and an adhesive material may be used which has a relatively low thermal conductivity for the gap pad 127. In this case, the heats of the LEDs 129a are quickly and efficiently released to the outside.

Meanwhile, in the present invention, loss of lights from the LEDs 129a can be minimized by the reflector 129 of FIG. 6. This will be explained in more detail with reference to accompanying drawings.

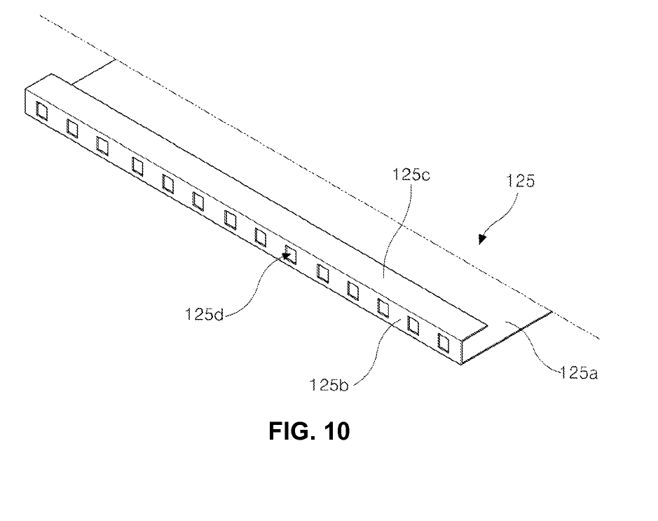

FIG. 10 is a perspective view of schematically illustrating a reflection plate 125 according to the present invention.

In FIG. 10, the reflection plate 125 is white- or silver-colored. The reflection plate 125 includes a bottom plane portion 125a and a side portion 125b and 125c that is twice bent upward and inward in the context of the figure and which is referred to as a bending portion hereinafter. The bottom plane portion 125a is disposed right over the bottom wall 151 of FIG. 9 of the cover bottom 150 of FIG. 9. The LEDs 129a of FIG. 9 of the LED assembly 129 of FIG. 9 are guided by the bending portion 125b and 125c of the reflection plate 125.

More particularly, the bending portion has a first bending side 125b and a second bending side 125c. The first bending side 125b extends from an edge of the bottom plane portion 125a upward in the context of the figure, and the second bending side 125c extends from an edge of the first bending side 125b inward in the context of the figure. The first bending side 125b is perpendicular to the bottom plane portion 125a. The second bending side 125c is perpendicular to the first bending side 125b and parallel to the bottom plane portion 125a.

At this time, the first bending side 125b includes a plurality of LED through-holes 125d. The LED assembly 129 of FIG. 9 is disposed at an outer surface of the first bending side 125b of the bending portion, and the LEDs 129a are put in respective LED through-holes 125d.

The bending portion 125b and 125c of the reflection plate 125 prevents light loss and concentrates lights emitted from the LEDs 129a of FIG. 9 onto the side of the light guide plate 123 as much as possible.

That is, the lights emitted from the LEDs 129a of FIG. 9 are guided by the bending portion 125b and 125c of the reflection plate 124 such that all the lights are incident on the inside of the light guide plate 123 of FIG. 6 through a light-incident surface of the light guide plate 123 of FIG. 6. The loss of the lights from the LEDs 129a can be prevented, and the brightness and image qualities of the LCD device may be increased.

Although not shown in the figure, the second bending side 125c of the reflection plate 124, beneficially, may have a width to cover the side of the light guide plate 123 of FIG. 6 including the light-incident surface, which faces the LED assembly 129 of FIG. 9.

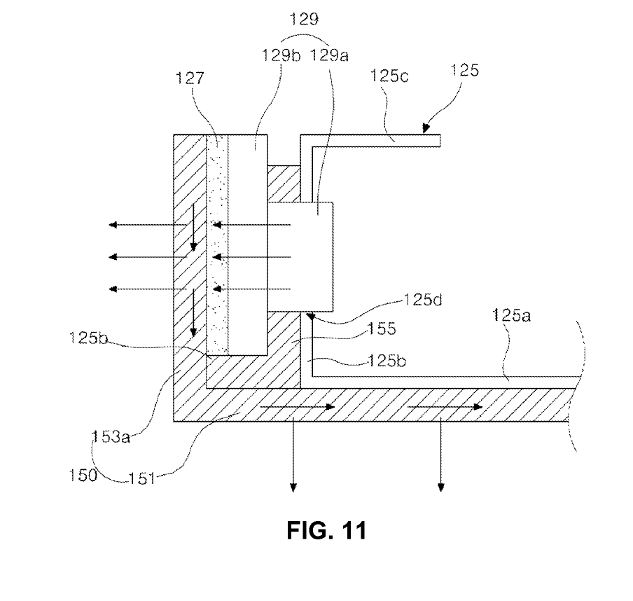

FIG. 11 is a cross-sectional view of schematically illustrating a structure of an LCD device of the first embodiment that adopts a reflection plate including a bending portion according to the present invention.

In FIG. 11, the LED assembly 129, which includes the MCPCB 129b and the LEDs mounted on the MCPCB 129b, and the gap pad 127, which is disposed at a rear surface of the LED assembly 129, are fixed by the fixing portions 155. The heats generated in the LEDs 129a are quickly and efficiently released to the outside.

The reflection plate 125 includes the bottom plane portion 125a and the side portion 125b and 125c. The bottom plane portion 125a is close up the bottom wall 151 of the cover bottom 150. The side portion includes the first bending side 125b, which is perpendicular to the bottom plane portion 125a and is close up an inner surface of the side wall 153a of the cover bottom 150, and the second bending side 125c, which is perpendicular to the first bending side 125b and guides the upper parts of the gap pad 127 and the LED assembly 129.

At this time, the first bending side 125b includes the plurality of LED through-holes 125d, the LED assembly 129 is disposed at the outer surface of the first bending side 125b, and the LEDs 129a mounted on the MCPCB 129b of the LED assembly 129 are put in respective LED through-holes 125d.

Accordingly, the LEDs 129a are exposed toward the light-incident surface of the light guide plate 123 of FIG. 3 through the LED through-holes 125d of the bending portion 125b and 125c.

This is a structure that the first bending side 125b does not obstruct the path of the heats when the heats generated in the LEDs 129a are conducted to the cover bottom 150 through the MCPCB 129b and the gap pad 127.

Although not shown in the figure, holes for the fixing portions 155 may be formed in the bottom plane portion 125a.

Like this, the lights emanated from the LEDs 129a are guided by the bending portion 125b and 125c of the reflection plate 125 such that all the lights are incident on the inside of the light guide plate 123 of FIG. 6 through the light-incident surface of the light guide plate 123 of FIG. 6. The loss of the lights of the LEDs 129a is prevented, and the brightness and image qualities of the LCD device are improved.

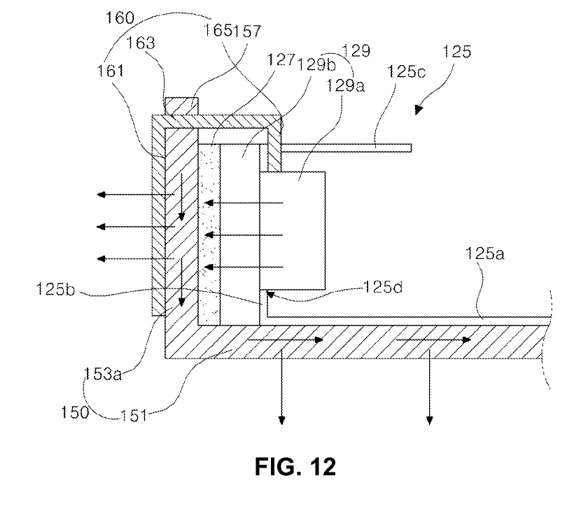

FIG. 12 is a cross-sectional view of schematically illustrating a structure of an LCD device of the second embodiment that adopts a reflection plate including a bending portion according to the present invention.

In FIG. 12, edges of the LED assembly 129, the gap pad 127, and the side wall 153a of the cover bottom 150 are covered and fixed by the fixing portions 155. The heats generated in the LEDs 129a are quickly and efficiently released to the outside.

The reflection plate 125 includes the bottom plane portion 125a and the side portion 125b and 125c. The bottom plane portion 125a is close up the bottom wall 151 of the cover bottom 150. The side portion includes the first bending side 125b, which is perpendicular to the bottom plane portion 125a and is close up an inner surface of the side wall 153a of the cover bottom 150, and the second bending side 125c, which is perpendicular to the first bending side 125b and guides the upper parts of the gap pad 127 and the LED assembly 129.

At this time, the first bending side 125b includes the plurality of LED through-holes 125d, the LED assembly 129 is disposed at the outer surface of the first bending side 125b, and the LEDs 129a mounted on the MCPCB 129b of the LED assembly 129 are put in respective LED through-holes 125d.

Namely, the LEDs 129a are exposed toward the light-incident surface of the light guide plate 123 of FIG. 3 through the LED through-holes 125d of the bending portion 125b and 125c.

Accordingly, the reflection plate 125 does not obstruct the path of the heats when the heats generated in the LEDs 129a are conducted to the cover bottom 150 through the MCPCB 129b and the gap pad 127.

In addition, the second bending side 125c includes through-holes for passing through the third guide portion 165 of the clip guide 160.

Therefore, the lights emanated from the LEDs 129a are guided by the bending portion 125b and 125c of the reflection plate 125 such that all the lights are incident on the inside of the light guide plate 123 of FIG. 6 through the light-incident surface of the light guide plate 123 of FIG. 6. The loss of the lights of the LEDs 129a is prevented. The brightness and image qualities of the LCD device are improved.

As stated above, the LCD device of the present invention includes the gap pad heat sink 127, which has a relatively high thermal conductivity and does not include an adhesive property, for radiating heat. Moreover, the fixing portion 155 of FIG. 11 is formed in the cover bottom 150 for fixing the gap pad heat sink 127 and the LEDs 129a, or the clip guide 160 is used to cover the gap pad heat sink 127, the LED assembly 129 and the side wall 153a of the cover bottom 150.

Accordingly, the heats generated in the LEDs 129a are quickly and efficiently released to the outside. It is prevented to shorten the lifespan of the LEDs 129a and to lower the image qualities due to change of the brightness.

Furthermore, the loss of the lights of the LED assembly 129 is prevented by forming the bending portion 125b and 125c in the reflection plate 125, and the brightness and image qualities of the LCD device are improved.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A liquid crystal display device, comprising:
a support main having a rectangular frame shape;
a reflection plate in the support main;
a light guide plate over the reflection plate;
a light-emitting diode (LED) assembly including LEDs arranged along a light-incident surface of the light guide plate and a metal core printed circuit board (MCPCB) on which the LEDs are mounted;
a thermal conductive means contacting the MCPCB and having a thermal conductivity within a range of 1.5 to 3 W/m·K;
a plurality of optical sheets over the light guide plate;
a liquid crystal panel over the plurality of optical sheets;
a cover bottom at a rear surface of the reflection plate and having a bottom wall and at least one side wall perpendicular to the bottom wall, wherein heats are conducted from the thermal conductive means to the at least one side wall; and
a top cover covering edges of a front surface of the liquid crystal and combined with the support main and the cover bottom.

2. The device according to claim 1, wherein the cover bottom has a fixing portion, and the fixing portion includes a first part parallel to the at least one side wall with a predetermined distance from the at least one side wall.

3. The device according to claim 2, wherein the fixing portion further includes a second part parallel to the bottom wall and connected to the first part and the at least one side wall.

4. The device according to claim 2, wherein the bottom wall corresponding to the first part is partially cut between the first part and the at least one side wall.

5. The device according to claim 2, wherein the thermal conductive means and the LED assembly are disposed between the first part and the at least one side wall.

6. The device according to claim 5, wherein the predetermined distance corresponding to thicknesses of the thermal conductive means and the LED assembly.

7. The device according to claim 5, wherein the first part has a height corresponding to a width of the MCPCB.

8. The device according to claim 5, wherein the first part is positioned between adjacent LEDs.

9. The device according to claim 5, wherein the thermal conductive means includes a gap pad.

10. The device according to claim 2, wherein the reflection plate includes a bending portion having a first bending side and a second bending side, and the first bending portion has LED through-holes corresponding to the LEDs.

11. The device according to claim 10, wherein the reflection plate has a hole for the fixing portion.

12. A liquid crystal display device, comprising:
a support main having a rectangular frame shape;
a reflection plate in the support main;
a light guide plate over the reflection plate;
a light-emitting diode (LED) assembly including LEDs arranged along a light-incident surface of the light guide plate and a metal core printed circuit board (MCPCB) on which the LEDs are mounted;
a thermal conductive means contacting the MCPCB;
a plurality of optical sheets over the light guide plate;
a liquid crystal panel over the plurality of optical sheets;
a cover bottom at a rear surface of the reflection plate and having a bottom wall and at least one side wall perpendicular to the bottom wall, wherein the thermal conductive means contacts the at least one side wall;
a top cover covering edges of a front surface of the liquid crystal and combined with the support main and the cover bottom; and
a clip guide covering the LED assembly, the thermal conductive means and the at least one side wall.

13. The device according to claim 12, wherein the clip guide includes a first guide portion, a second guide portion and a third guide portion, wherein the first guide portion is disposed at an outer surface of the at least one side wall, the second guide portion is perpendicular to the first guide portion, and the third guide portion is perpendicular to the second guide portion and parallel to the first guide portion, wherein the third guide portion is disposed at a surface of the MCPCB.

14. The device according to claim 13, wherein the second guide portion has connection holes and the at least one side wall has protrusions corresponding to the connection holes.

15. The device according to claim 13, wherein the third guide portion has guide projections, and each of the guide projections is disposed between adjacent LEDs.

16. The device according to claim 12, wherein the first guide portion has a height corresponding to a height of the at least one side wall.
